(19) United States
(12) Patent Application Publication
(10) Pub. No.: US 2012/0043212 A1
(43) Pub. Date: Feb. 23, 2012

(54) REAL-TIME FLUORESCENT ELECTROPHORESIS APPARATUS

(76) Inventors: Wei-Li HONG, Hsin-Chu (TW); Yuan Yu Tsai, Hsin-Chu (TW); Yueh-Chu Tien, Hsin-chu (TW); Shuo-Ting Yan, Hsin-chu (TW); Sy-Haw Wang, Hsin-chu (TW)

(21) Appl. No.: 12/961,259

(22) Filed: Dec. 6, 2010

(30) Foreign Application Priority Data
Aug. 20, 2010 (TW) 099127877

(51) Int. Cl. G01N 27/00

(52) U.S. Cl. 204/606

(57) ABSTRACT

A real-time fluorescent electrophoresis apparatus, comprising: an electrophoresis tank comprising a platform, an electrophoresis liquid, a positive electrode and a negative electrode, the platform carrying a gel with a biological sample, the gel comprising a plurality of charged molecules of the biological sample, and the gel, the platform, the positive electrode and the negative electrode being immersed in the electrophoresis liquid; and a lid covering the electrophoresis tank and comprising a filter disposed above the gel and at least one luminous element disposed on at least one side of the filter to irradiate the gel so that the biological sample in the gel is excited to fluoresce. Thereby, the experimenter is able to observe fluorescence phenomenon from the biological sample during electrophoresis so as to trace the electrophoresis process and determine whether the electrophoresis process is to be interrupted and avoid experimental errors.

### 1. FIELD OF THE INVENTION

The present invention generally relates to a real-time fluorescent electrophoresis apparatus and, more particularly, to a real-time fluorescent electrophoresis apparatus whereby the experimenter is able to observe fluorescence phenomenon from a biological sample during electrophoresis so as to trace the electrophoresis process and determine whether the electrophoresis process is to be interrupted and avoid experimental errors.

### 2. BACKGROUND OF THE INVENTION

Electrophoresis is usually used for analysis of biological samples (such as DNA's or proteins) to obtain molecular weights, degrees of purity or structures thereof.

Generally, before DNA electrophoresis, the DNA's are loaded into a gel. The gel electrophoresis technique includes agarose gel electrophoresis (AGE) for separating DNA fragments with heavier molecular weights (for example, 1 to 60000 bp) and polyacrylamide gel electrophoresis (PAGE) for separating DNA fragments with lighter molecular weights (for example, 1 to 1000 bp).

During gel electrophoresis, an electric field is applied to drive DNA molecules in the gel to move towards the positive electrode since the DNA molecules are negatively charged. Due to the difference in molecular weights, the moving speeds of the DNA molecules vary. Moreover, the DNA molecules are often dyed by a dying agent (such as EtBr) before they are exposed to light with a certain wavelength. The dying agent fluoresces after the light is absorbed so that the DNA molecules are observed and identified after electrophoresis.

As shown in FIG. 1 for a structural diagram of a conventional electrophoresis apparatus, the electrophoresis apparatus 100 comprises an electrophoresis tank 10, a gel 11 with a biological sample and a power supply unit 13. The gel 11 comprises a plurality of charged molecules 111 (such as DNA molecules). The biological sample has dyed by a dying agent. The electrophoresis tank 10 comprises a platform 101, an electrophoresis liquid 103, a positive electrode 105 and a negative electrode 107. The gel 11 is placed on the platform 101. The gel 11, the platform 101, the positive electrode 105 and the negative electrode 107 are immersed in the electrophoresis liquid 103. The power supply unit 13 provides DC power and is electrically connected to the positive electrode 105 and the negative electrode 107.

When the power supply unit 13 provides DC power, an electric field is built across the positive electrode 105 and the negative electrode 107 so as to drive the charged molecules 111 in the gel 11 to move towards the electrodes 105/107 with opposite electric polarities. For example, the charged molecules 111 move towards the positive electrode 105 when they are negatively charged, while the charged molecules 111 move towards the negative electrode 107 when they are positively charged. Moreover, the moving speeds of the charged molecules 111 depend on the molecular weights thereof. In other words, the charged molecules 111 with heavier molecular weights exhibit lower speed than the charged molecules 111 with lighter molecular weights. Therefore, there exists difference in the traveling lengths of the charged molecules 111 with different molecular weights in the gel 11 after a certain period of electrophoresis time.

The gel 11 having experienced electrophoresis is unloaded from the electrophoresis tank 10 and is then irradiated by a light apparatus (not shown) so that the charged molecules 111 in the gel 11 fluoresce. Thereby, the charged molecules 111 can be identified by observing the positional change of the charged molecules 111.

Accordingly, the biological sample in the gel 11 may undergo electrophoresis using a conventional electrophoresis apparatus 100. However, during the electrophoresis process, the moving speeds of the charged molecules 111 of the biological sample under an applied electric field may vary, which results in different electrophoresis time periods in the same gel 11. Presently, there is no method that is capable of precisely calculating the moving speeds of the charged molecules 111 during electrophoresis. If the biological sample to undergo electrophoresis has experienced the experiment, the time required for electrophoresis of the biological sample can be empirically estimated. On the contrary, if the biological sample to undergo electrophoresis has not experienced the experiment, the time required for electrophoresis can be obtained by trial and error. In other words, after each electrophoresis process, the experimenter has to check whether the electrophoresis result is satisfactory by using a light apparatus. The electrophoresis time has to be adjusted if the electrophoresis result is not satisfactory. Therefore, the charged molecules 111 with different molecular weights in the gel 11 can be identified so as to avoid that the electrophoresis time is too short unable to separate the charged molecules 111 with different molecular weights in the gel 11 and that the electrophoresis time is so long that all the charged molecules 111 with different molecular weights drift from the gel 11 into the electrophoresis liquid 103.

In view of the above, the present invention provides a real-time fluorescent electrophoresis apparatus, in which the experimenter is able to observe fluorescence phenomenon from the biological sample during electrophoresis so as to trace the electrophoresis process and determine whether the electrophoresis process is to be interrupted and avoid experimental errors.

### SUMMARY OF THE INVENTION

It is one object of the present invention to provide a real-time fluorescent electrophoresis apparatus, whereby the experimenter is able to observe fluorescence phenomenon from a biological sample during electrophoresis so as to trace the electrophoresis process and determine whether the electrophoresis process is to be interrupted and avoid experimental errors.

It is another object of the present invention to provide a real-time fluorescent electrophoresis apparatus, in which at least one anti-fog element is disposed on one surface or one side of the filter so as to prevent the vapor of the electrophoresis liquid being condensed on the filter to hinder the experimenter observing the fluorescence phenomenon from the biological sample.

It is still another object of the present invention to provide a real-time fluorescent electrophoresis apparatus, in which an air flow is conducted so as to carry away the vapor inside the real-time fluorescent electrophoresis apparatus and prevent the vapor being condensed on the filter to hinder the experimenter observing the fluorescence phenomenon from the biological sample.

To achieve the above objects, the present invention provides an real-time fluorescent electrophoresis apparatus, comprising: an electrophoresis tank comprising a platform, an electrophoresis liquid, a positive electrode and a negative electrode, the platform carrying a gel with a biological sample, the gel comprising a plurality of charged molecules of the biological sample, and the gel, the platform, the positive electrode and the negative electrode being immersed in the electrophoresis liquid; a lid covering the electrophoresis tank and comprising a filter disposed above the gel and at least one luminous element disposed on at least one side of the filter to irradiate the gel so that the biological sample in the gel is excited to fluoresce; and a power supply unit electrically connected to the positive electrode, the negative electrode and the luminous element so that an electric field is built across the positive electrode and the negative electrode to drive the charged molecules to move in the gel and provide the luminous element with electricity to luminesce.

The present invention further provides a real-time fluorescent electrophoresis apparatus, comprising: an electrophoresis tank comprising a platform, an electrophoresis liquid, a positive electrode and a negative electrode, the platform being transparent and carrying a gel with a biological sample, the gel comprising a plurality of charged molecules of the biological sample, the platform comprising at least one luminous element therein to irradiate the gel on the platform so that the biological sample in the gel is excited to fluoresce, and the gel, the platform, the positive electrode and the negative electrode being immersed in the electrophoresis liquid; a lid covering the electrophoresis tank and comprising a filter disposed above the gel; and a power supply unit electrically connected to the positive electrode, the negative electrode and the luminous element so that an electric field is built across the positive electrode and the negative electrode to drive the charged molecules to move in the gel and provide the luminous element with electricity to luminesce.

The present invention another provides a real-time fluorescent electrophoresis apparatus, comprising: an electrophoresis tank comprising a platform, an electrophoresis liquid, a positive electrode and a negative electrode, the platform being transparent and carrying a gel with a biological sample, the gel comprising a plurality of charged molecules of the biological sample, the platform comprising at least one luminous element therein to irradiate the gel on the platform so that the biological sample in the gel is excited to fluoresce, and the gel, the platform, the positive electrode and the negative electrode being immersed in the electrophoresis liquid; a base comprising a bottom portion and a vertical portion, the electrophoresis tank disposed on the bottom portion, the bottom portion comprising an inlet fan with a air inlet and the vertical portion comprising an aperture to define a air flow path between the air inlet and the aperture so that a air flow is driven by the inlet fan into the air inlet to pass the air flow path and is discharged from the aperture; a filter disposed above the gel and fixedly on the vertical portion of the base so that a gap is defined between the filter and the electrophoresis tank; a air outlet disposed opposite to the gap so that the air flow discharged from the aperture passes through the gap to carry away the vapor on the filter out of the air outlet; and a power supply unit electrically connected to the positive electrode, the negative electrode, the luminous element and the inlet fan so as to build up an electric field across the positive electrode and the negative electrode to move the charged molecules in the gel and provide the luminous element and the inlet fan with electricity.

### BRIEF DESCRIPTION OF THE DRAWINGS

The objects and spirits of the embodiments of the present invention will be readily understood by the accompanying drawings and detailed descriptions, wherein:

FIG. 1 is a structural diagram of a conventional electrophoresis apparatus;

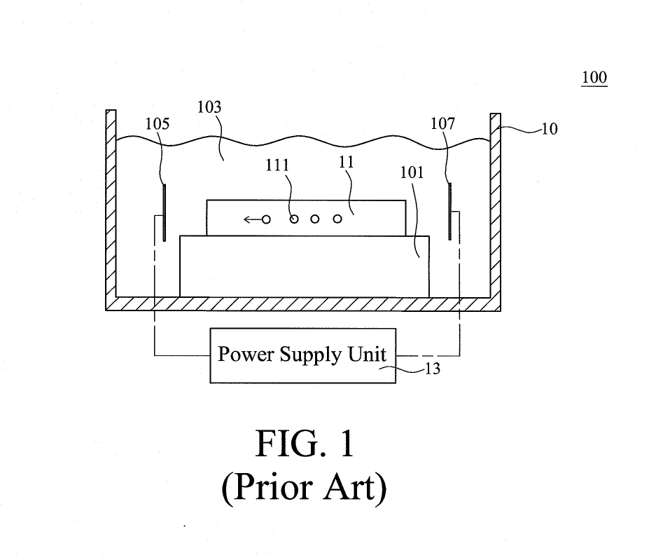

FIG. 2 is a structural diagram of a real-time fluorescent electrophoresis apparatus according to one preferred embodiment of the present invention;

FIG. 3 is a top view of a real-time fluorescent electrophoresis apparatus according to the present invention;

FIG. 4 is a structural diagram of a real-time fluorescent electrophoresis apparatus according to another embodiment of the present invention;

FIG. 5 is a structural diagram of a real-time fluorescent electrophoresis apparatus according to another embodiment of the present invention;

FIG. 6 is a structural diagram of a real-time fluorescent electrophoresis apparatus according to another embodiment of the present invention;

FIG. 7 is a structural diagram of a real-time fluorescent electrophoresis apparatus according to another embodiment of the present invention;

FIG. 8 is a structural diagram of a real-time fluorescent electrophoresis apparatus according to another embodiment of the present invention;

FIG. 9 is a structural diagram of a real-time fluorescent electrophoresis apparatus according to another embodiment of the present invention;

FIG. 10 is a structural diagram of a real-time fluorescent electrophoresis apparatus according to another embodiment of the present invention;

FIG. 11 is a stereogram of a real-time fluorescent electrophoresis apparatus according to another embodiment of the present invention;

FIG. 12 is an upside-down stereogram of a real-time fluorescent electrophoresis apparatus according to another embodiment of the present invention;

FIG. 13 is a structural diagram of a real-time fluorescent electrophoresis apparatus according to another embodiment of the present invention;

FIG. 14 is a stereogram of a real-time fluorescent electrophoresis apparatus according to another embodiment of the present invention;

FIG. 15 is a structural diagram of a real-time fluorescent electrophoresis apparatus according to another embodiment of the present invention;

FIG. 16 is a stereogram of a real-time fluorescent electrophoresis apparatus according to another embodiment of the present invention;

FIG. 17 is an upside-down stereogram of a real-time fluorescent electrophoresis apparatus according to another embodiment of the present invention; and

FIG. 18 is a perspective view of a real-time fluorescent electrophoresis apparatus according to another embodiment of the present invention.

### DETAILED DESCRIPTION OF THE PREFERRED EMBODIMENTS

The present invention can be exemplified but not limited by various embodiments as described hereinafter.

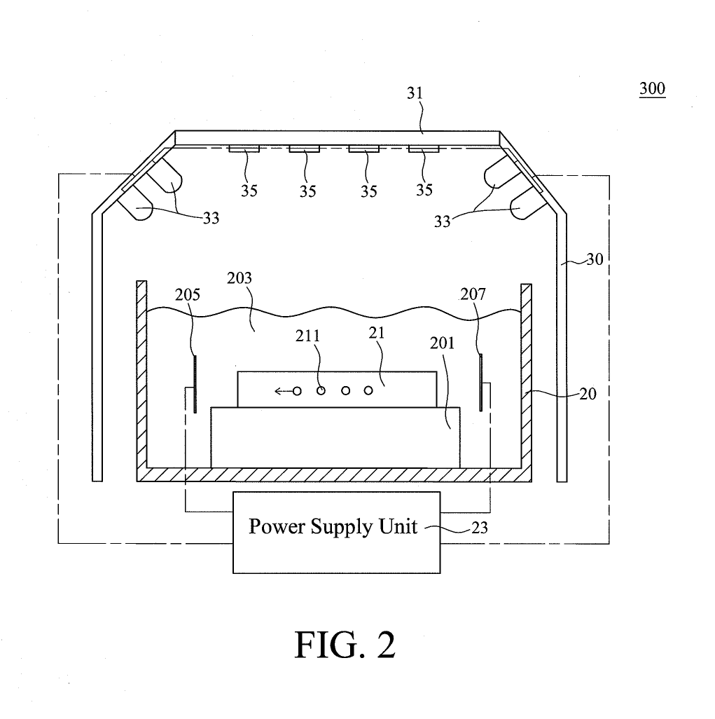

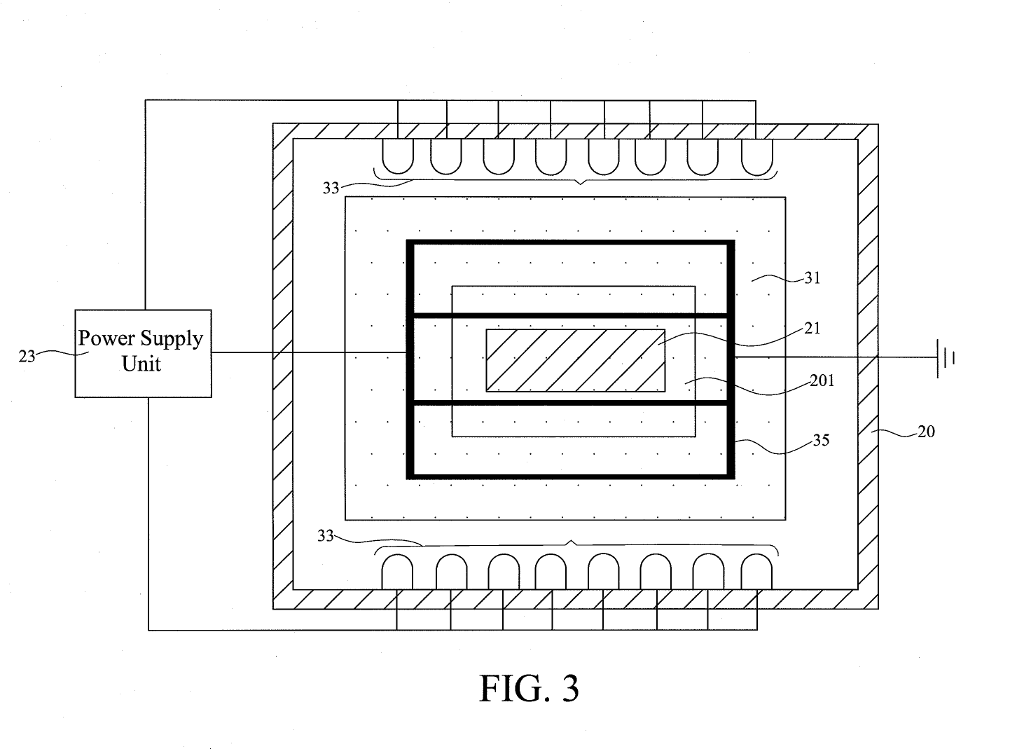

Please refer to FIG. 2 and FIG. 3 for a structural diagram and a top view of a real-time fluorescent electrophoresis apparatus according to one preferred embodiment of the present invention. The real-time fluorescent electrophoresis apparatus 20 of the present embodiment comprises an electrophoresis tank 20, a lid 30 and a power supply unit 23.

The electrophoresis tank 20 comprises a platform 201, an electrophoresis liquid 203, a positive electrode 205 and a negative electrode 207. The platform 201 carries a gel 21 with a biological sample (such as protein, DNA, RNA, etc). The gel 21 comprises a plurality of charged molecules 211 of the biological sample that has dyed by a dying agent. The gel 21, the platform 201, the positive electrode 205 and the negative electrode 207 are immersed in the electrophoresis liquid 203. The lid 30 covers and surrounds the electrophoresis tank 20. The lid 30 comprises a filter 31 and at least one luminous element 33. The filter 31 is an amber filter disposed above the gel 21. The luminous element 33 is inclinedly disposed on at least one side of the filter 31 to irradiate the gel 21. The irradiation zone of the luminous element 33 covers the gel 21 to excite the biological sample in the gel 21 to fluoresce. The power supply unit 23 is a DC power supply unit and is electrically connected to the positive electrode 205, the negative electrode 207 and the luminous element 33 to provide the positive electrode 205, the negative electrode 207 and the luminous element 33 with electricity.

During electrophoresis, the power supply unit 23 provides electricity so that an electric field is built across the positive electrode 205 and the negative electrode 207 so as to drive the charged molecules 211 in the gel 21 to move towards the electrodes 205/207 with opposite electric polarities. For example, the charged molecules 211 move towards the positive electrode 205 when they are negatively charged, while the charged molecules 211 move towards the negative electrode 207 when they are positively charged. Meanwhile, the luminous element 33 luminesces to irradiate the gel 21 to excite the biological sample in the gel 21 to fluoresce. Moreover, when the experimenter observes the fluorescence phenomenon from the charged molecules 211 of the biological sample through the filter 31, the filter 31 is able to filter out the light from the luminous element 33 and allows only the fluorescence from the biological sample to pass therethrough.

Accordingly, the experimenter is able to observe the positional change of the charged molecules 211 of the biological sample in the gel 21 in real time to trace the electrophoresis process. Therefore, the experimenter can determine whether the electrophoresis process is to be interrupted and avoid experimental errors according to the positions of the charged molecules 211 in the gel 21.

In the present invention, the luminous element 33 is a light-emitting diode capable of irradiating the gel 21 by emitting monochromatic light such as blue, ultraviolet or green light. Moreover, the luminous element 33 is inclinedly disposed with an adjustable inclined angle corresponding to the position of the gel 21. The number of luminous elements can be larger than one so as to achieve improved irradiation according to practical demands.

Furthermore, during electrophoresis, the electrophoresis liquid 203 is heated up by the electric field to cause vapor to be condensed on the filter 31, which hinders the experimenter observing the fluorescence phenomenon from the biological sample. Therefore, in the present invention, at least one anti-fog element 35 may be disposed on one surface (for example, the bottom surface) of the filter 31. The anti-fog element 35 comprises at least one thermal wire and is electrically connected to the power supply unit 23 to provide electricity. When the anti-fog element 35 is turned on, the anti-fog element 35 is heated up to keep the filter 31 at a temperature higher than the room temperature so as to prevent the vapor of the electrophoresis liquid 203 being condensed on the filter 31 to hinder the experimenter observing the fluorescence phenomenon from the biological sample.

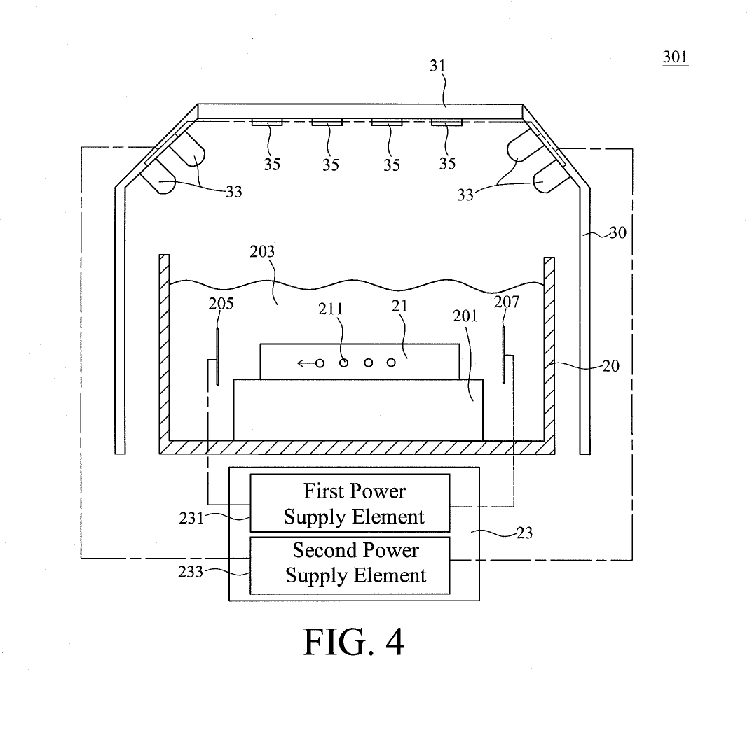

Please refer to FIG. 4, which is a structural diagram of a real-time fluorescent electrophoresis apparatus according to another embodiment of the present invention. In the present embodiment, the electrophoresis tank 20 and the lid 30 in the real-time fluorescent electrophoresis apparatus 301 may be powered by respective power supply elements. For example, the power supply unit 23 may comprise a first power supply element 231 and a second power supply element 233. The first power supply element 231 provides the positive electrode 205 and the negative electrode 207 with electricity, while the second power supply element 233 provides the luminous element 33 and the anti-fog element 35 with electricity. The second power supply element 233 is a power control element capable of determining whether the luminous element 33 is to be turned on and whether the anti-fog element 35 provides thermal energy.

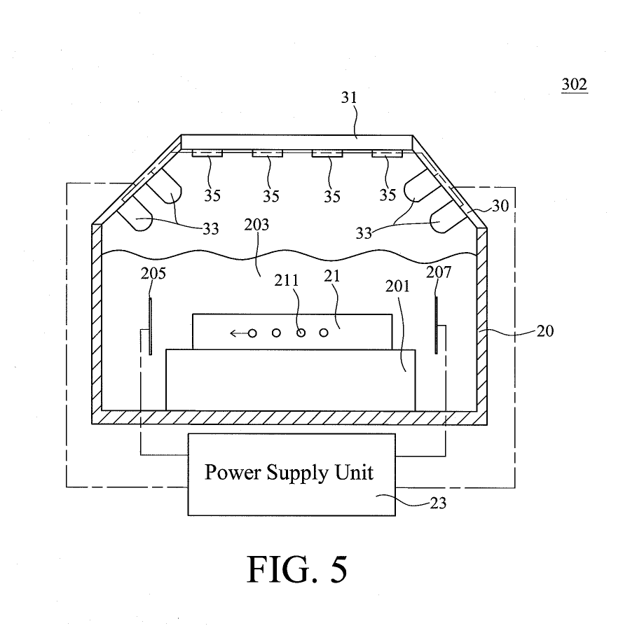

Please refer to FIG. 5, which is a structural diagram of a real-time fluorescent electrophoresis apparatus according to another embodiment of the present invention. In addition to the embodiment shown in FIG. 2 where the lid 30 of the real-time fluorescent electrophoresis apparatus 300 is disposed surrounding the electrophoresis tank 20, the lid 30 of the real-time fluorescent electrophoresis apparatus 302 may be fixedly constructed on the electrophoresis tank 20, as shown in FIG. 5.

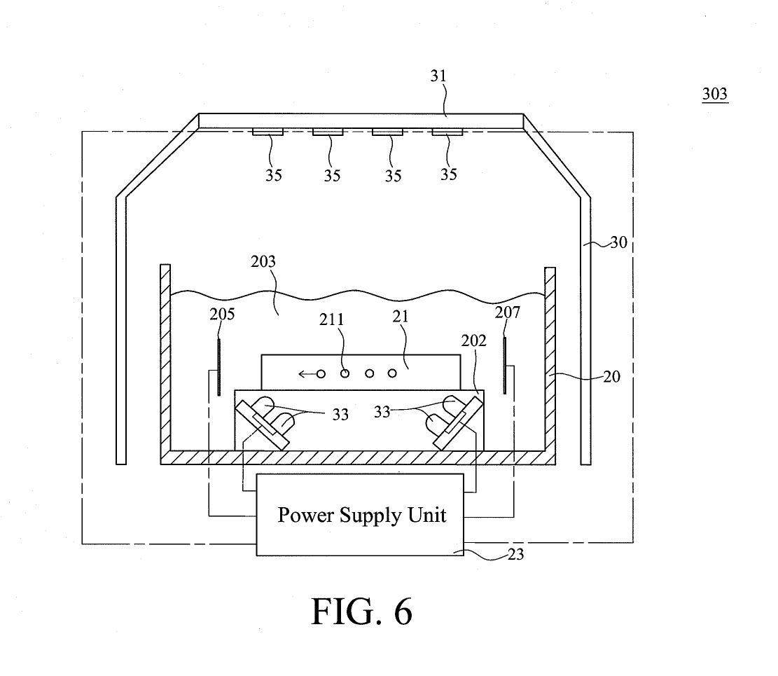

Please refer to FIG. 6, which is a structural diagram of a real-time fluorescent electrophoresis apparatus according to another embodiment of the present invention. In addition to the foregoing embodiments wherein the luminous element 33 of the real-time fluorescent electrophoresis apparatus 300/301/302 is disposed on one side of the filter 31 of the lid 30, the luminous element 33 of the real-time fluorescent electrophoresis apparatus 303 of the present embodiment may also be disposed inside the platform 202 of the electrophoresis tank 20, as shown in FIG. 6.

The platform 202 of the present embodiment is a transparent platform capable of carrying a gel 21 with biological samples thereon. At least one luminous element 33 is inclinedly disposed on one side inside the platform 202 to upward irradiate the gel 21 on the platform 202. The biological sample in the gel 21 is excited to fluoresce. Thereby, the experimenter is able to observe the positional change of the charged molecules 211 of the biological sample in the gel 21 through the filter 31 to trace the electrophoresis process in real time. Moreover, the real-time fluorescent electrophoresis apparatus 303 of the present embodiment is similarly to the structure of the embodiment as shown in FIG. 2 except the luminous element 33, and thus description thereof is not to be repeated herein.

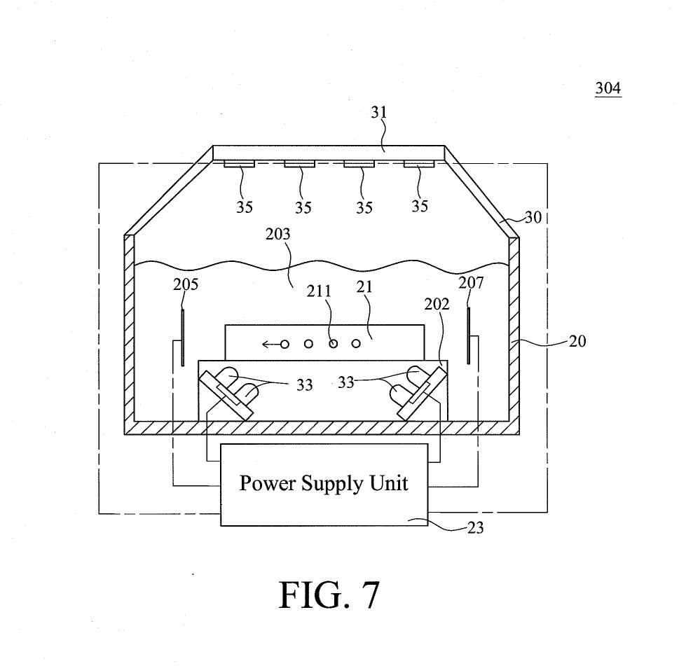

Please refer to FIG. 7, which is a structural diagram of a real-time fluorescent electrophoresis apparatus according to another embodiment of the present invention. The real-time fluorescent electrophoresis apparatus 304 of the present embodiment is similar to the real-time fluorescent electrophoresis apparatus 303 of the embodiment as shown in FIG. 6 except that the lid 30 of the real-time fluorescent electrophoresis apparatus 304 is fixedly constructed on the electrophoresis tank 20 instead of being disposed surrounding the real-time fluorescent electrophoresis apparatus 303.

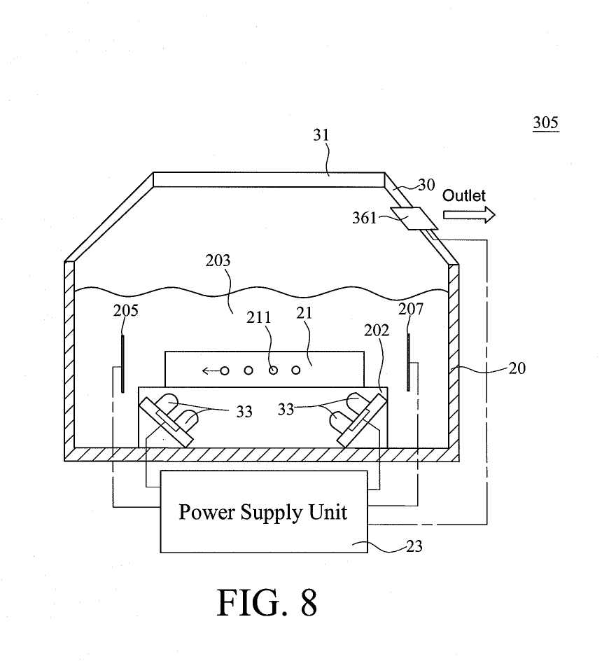

Please refer to FIG. 8, which is a structural diagram of a real-time fluorescent electrophoresis apparatus according to another embodiment of the present invention. Compared to the real-time fluorescent electrophoresis apparatus 304 of the embodiment in FIG. 7 where a thermal wire is disposed on one surface of the filter 31 as an anti-fog element 35, an outlet fan may also be used as an anti-fog element 361 of the real-time fluorescent electrophoresis apparatus 305 of the present embodiment. The anti-fog element 361 is disposed on one side of the filter 31 so as to deflate the electrophoresis tank 20 and prevent the vapor of the electrophoresis liquid 203 being condensed on the filter 31.

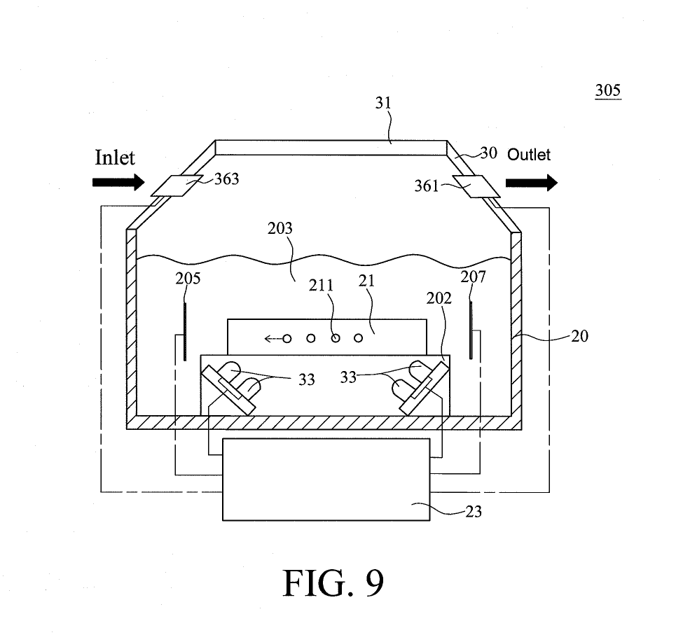

Alternatively, as shown in FIG. 9, another anti-fog element 363 may be provided on another side of the filter 31. An inlet fan may be used as the anti-fog element 363 so as to inflate the real-time fluorescent electrophoresis apparatus 305. By the use of the inlet fan 363 and the outlet fan 361, an air flow is conducted inside the real-time fluorescent electrophoresis apparatus 305 so as to carry away the vapor inside the real-time fluorescent electrophoresis apparatus 305 and prevent the vapor being condensed on the filter 31.

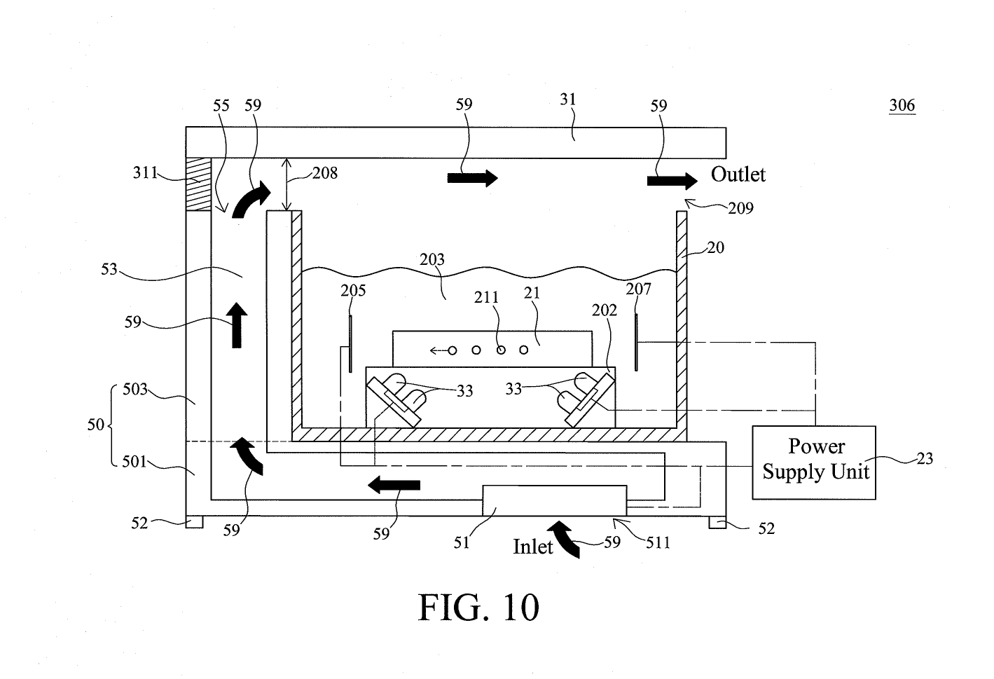

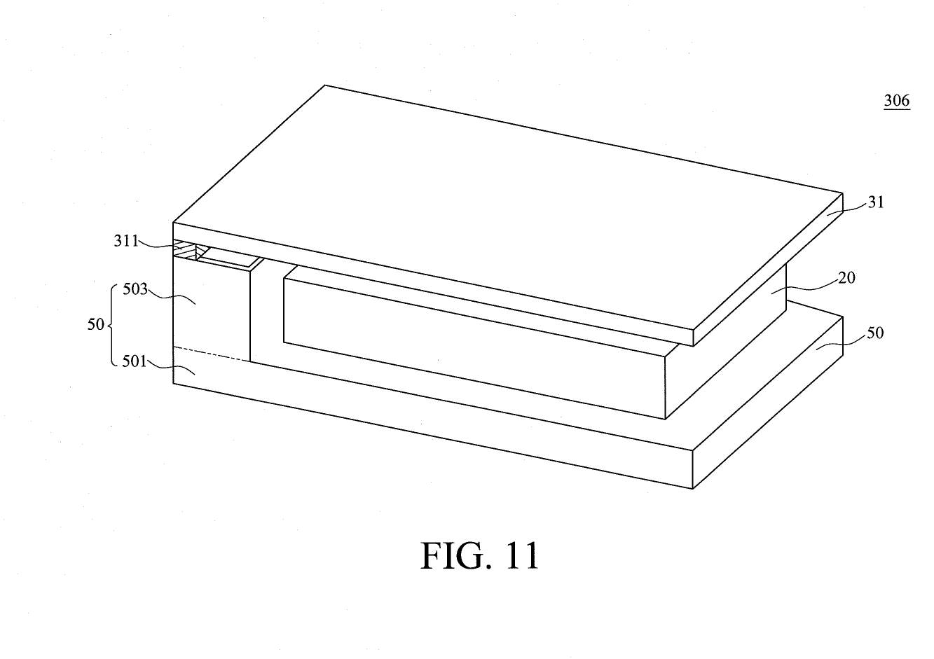

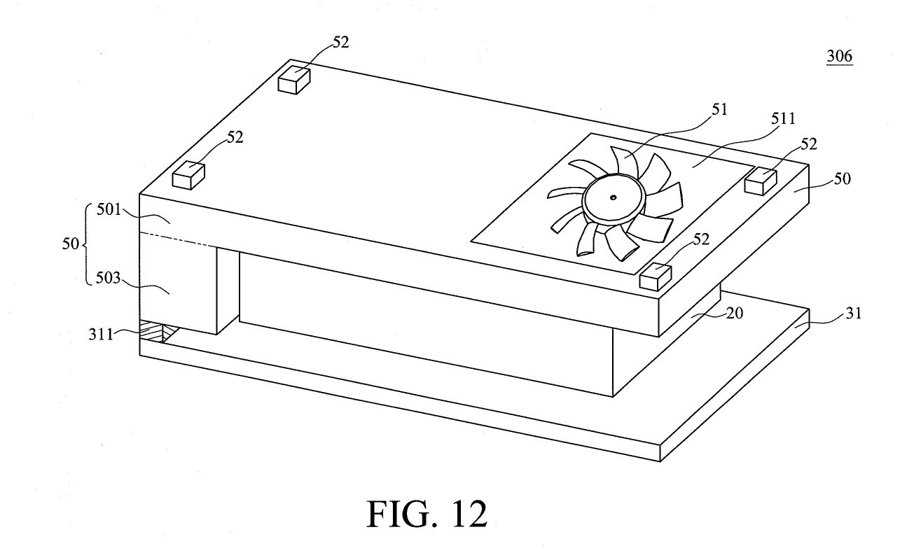

Moreover, in addition to the air flow for carrying away the vapor inside the electrophoresis tank 20, the present invention further provides other embodiments, as shown in FIG. 10, FIG. 11 and FIG. 12 for a structural diagram, a stereogram and an upside-down stereogram of a real-time fluorescent electrophoresis apparatus according to another embodiment of the present invention. The real-time fluorescent electrophoresis apparatus 306 of the present embodiment comprises an electrophoresis tank 20, a base 50 and a power supply unit 23.

In the present embodiment, the electrophoresis tank 20 comprises a platform 202, an electrophoresis liquid 203, a positive electrode 205 and a negative electrode 207. The platform 202 is transparent and is capable of carrying a gel 21 with a biological sample (such as protein, DNA, RNA, etc). The gel 21 comprises a plurality of charged molecules 211 of the biological sample that has dyed by a dying agent. The gel 21, the platform 202, the positive electrode 205 and the negative electrode 207 are immersed in the electrophoresis liquid 203. At least one luminous element 33 is inclinedly disposed on at least one side inside the platform 202 to upward irradiate the gel 21 on the platform 202. The biological sample in the gel 21 is excited to fluoresce.

The base 50 is hollow and comprises a bottom portion 501 and a vertical portion 503. The electrophoresis tank 20 is disposed on the bottom portion 501, which is provided with an inlet fan 51 having an air inlet 511. The vertical portion 503 is provided with an aperture 55 so that an air flow path 53 is defined between the air inlet 511 and the aperture 55. A filter 31 is disposed above the gel 21 and is fixedly disposed on the vertical portion 503 of the base 50 by contacting of a connecting portion 311. A gap 208 is defined between the filter 31 and the electrophoresis tank 20 and an air outlet 209 is provided opposite to the gap 208. The power supply unit 23 may be a DC power supply unit and is electrically connected to the positive electrode 205, the negative electrode 207, the luminous element 33 and the inlet fan 51 so as to provide the positive electrode 205, the negative electrode 207, the luminous element 33 and the inlet fan 51 with electricity.

During electrophoresis, the electrophoresis liquid 203 in the electrophoresis tank 20 is heated up by the electric field across the positive electrode 205 and the negative electrode 207 to generate the vapor onto the filter 31. Meanwhile, an air flow 59 is driven by the inlet fan 51 into the air inlet 511 to pass the air flow path 53 and is discharged from the aperture 55. The discharged air flow 59 then passes through the gap 208 to carry away the vapor on the filter 31 out of the air outlet 209. Thereby, the vapor is prevented being condensed on the filter 31 to hinder the experimenter observing the fluorescence phenomenon from the biological sample.

In the present embodiment, the air inlet 511 is provided on the bottom surface of the bottom portion 501. A plurality of pillars 52 may be further provided on the bottom surface of the bottom portion 501 so that there is more space between the air inlet 511 and a planar surface for the inlet fan 51 to introduce the air flow 59 into the air inlet 511 when the real-time fluorescent electrophoresis apparatus 306 is placed on the planar surface.

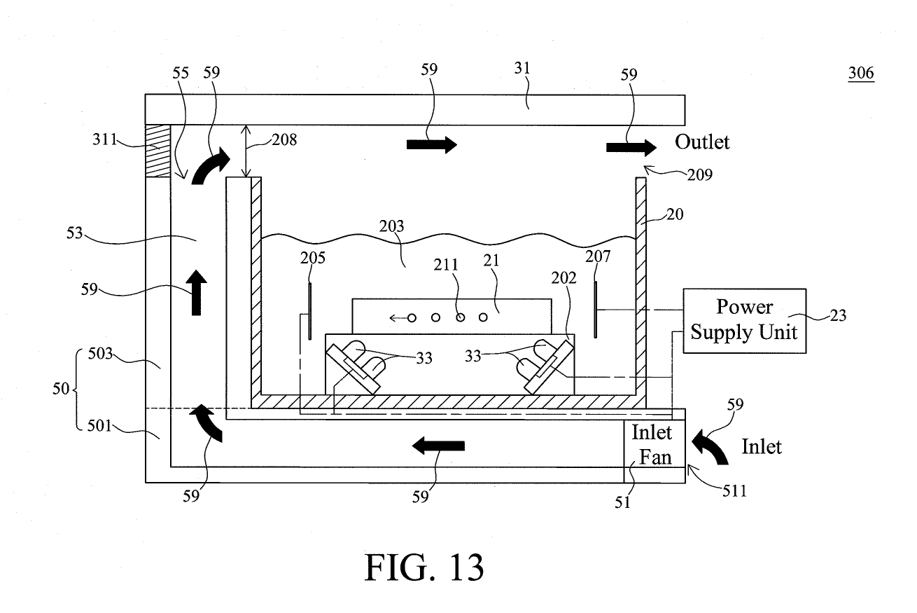

As shown in FIG. 13, the air inlet 511 of the real-time fluorescent electrophoresis apparatus 306 may also be disposed on one lateral side of the bottom portion 501. In this case, the pillars 52 are not required.

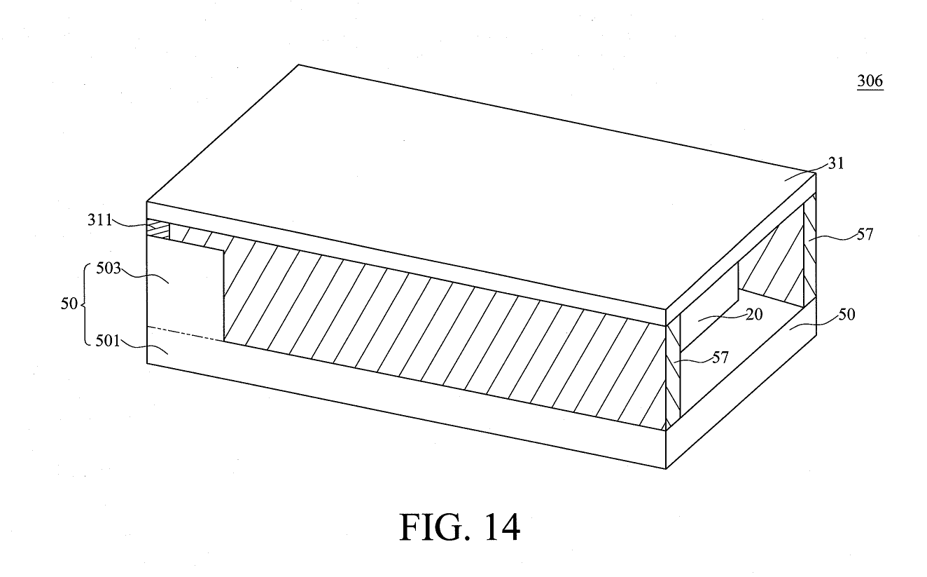

As shown in FIG. 14, to further enhance the air flow 59, the real-time fluorescent electrophoresis apparatus 306 may further comprise a pair of side plates 57 disposed on both sides of the base 50. As a result, the discharged air flow 59 from the aperture 55 will not be weakened due to dissipation from the two sides of the base 50. Thereby, the air flow 59 with constant strength is able to carry away the vapor on the filter 31 out of the air outlet 209.

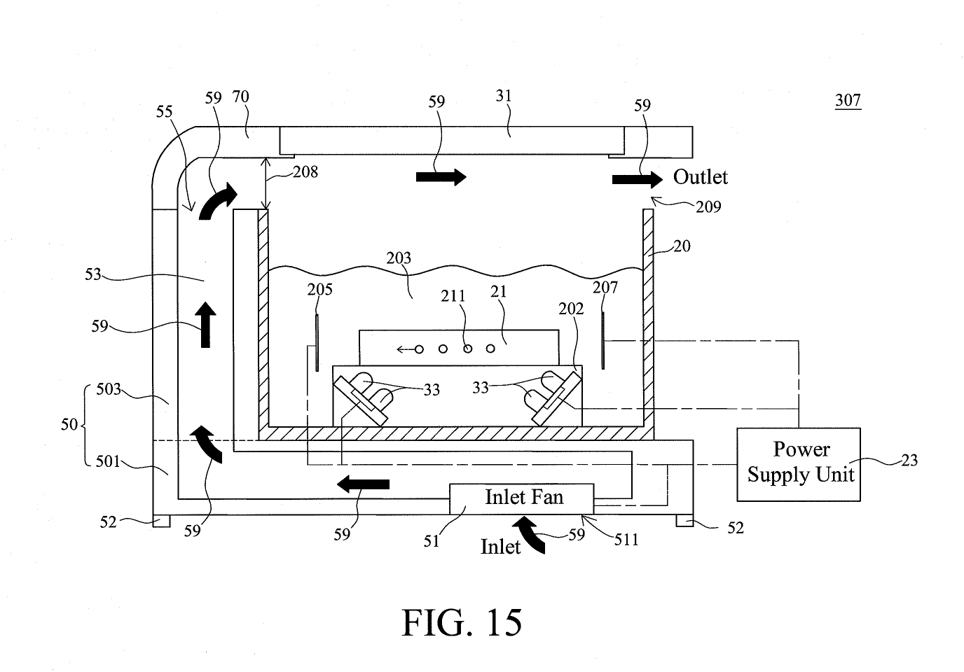

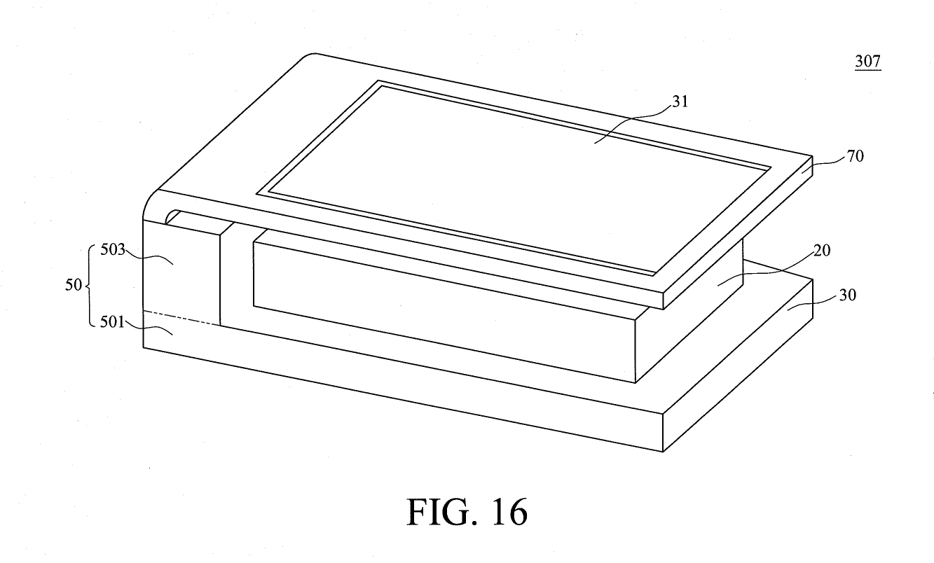

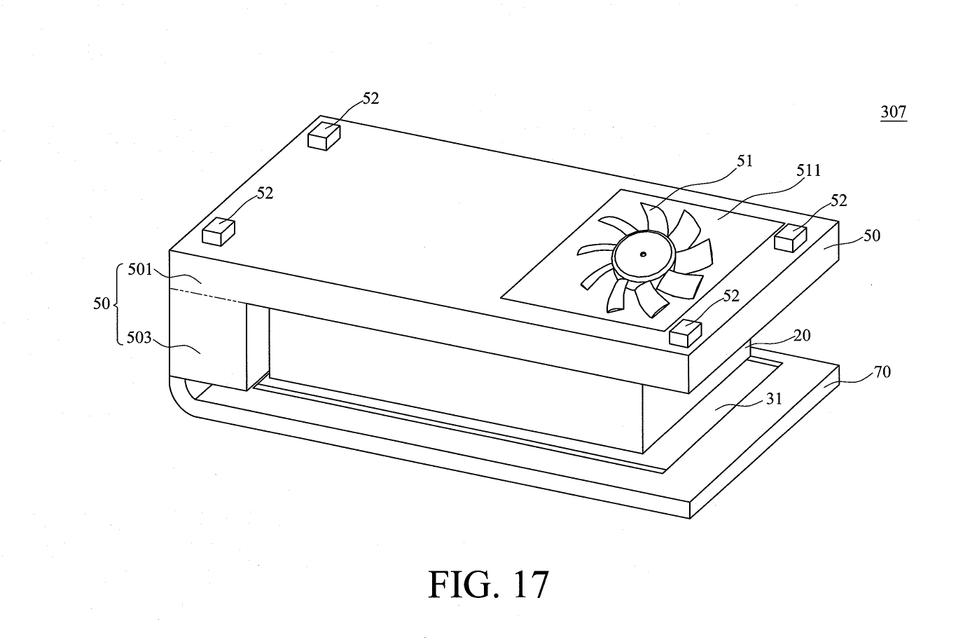

Please refer to FIG. 15, FIG. 16 and FIG. 17 for a structural diagram, a stereogram and an upside-down stereogram of a real-time fluorescent electrophoresis apparatus according to another embodiment of the present invention. The real-time fluorescent electrophoresis apparatus 306 of the present embodiment comprises an electrophoresis tank 20, a base 50 and a power supply unit 23. The real-time fluorescent electrophoresis apparatus 307 of the present embodiment is similar to the real-time fluorescent electrophoresis apparatus 306 of the previous embodiment except that the filter 31 of the real-time fluorescent electrophoresis apparatus 307 may also be disposed on a side frame 70 instead of being fixedly disposed on the vertical portion 503 of the base 50 by contacting of a connecting portion 311 of the real-time fluorescent electrophoresis apparatus 306 of the previous embodiment. However, the filter 31 of the real-time fluorescent electrophoresis apparatus 307 of present embodiment may also be disposed on the side frame 70 that is fixedly disposed on the vertical portion 503 of the base 50.

Moreover, in the present embodiment, the side frame 70 and the base 50 may be made of the same material so that the two can be tightly adhered to each other. Thereby, the filter 31 is fixedly disposed on the base 50 without risk of falling down.

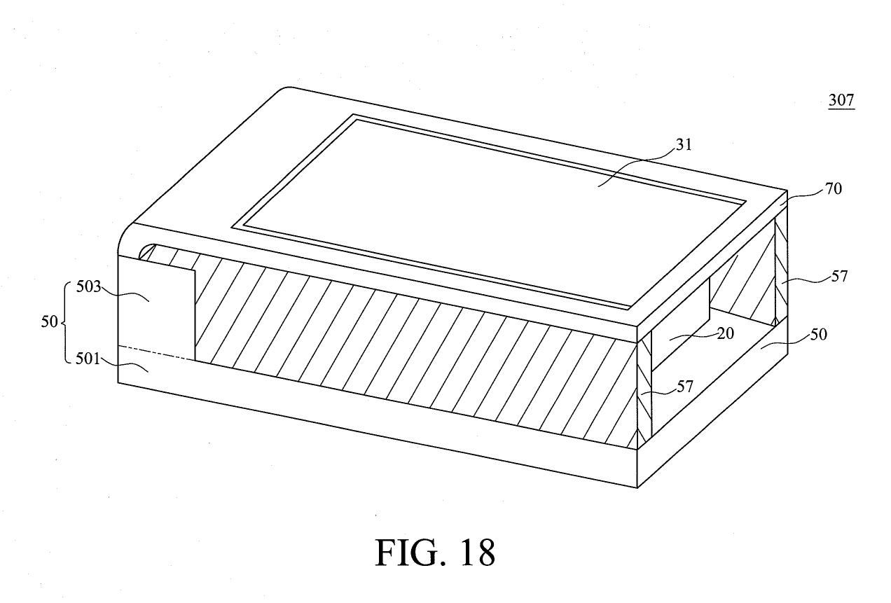

As shown in FIG. 18, the real-time fluorescent electrophoresis apparatus 307 may also comprise a pair of side plates 57 disposed on both sides of the base 50 so that the air flow 59 with constant strength is able to carry away the vapor on the filter 31 out of the air outlet 209.

Although this invention has disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A real-time fluorescent electrophoresis apparatus, comprising:
an electrophoresis tank comprising a platform, an electrophoresis liquid, a positive electrode and a negative electrode, the platform carrying a gel with a biological sample, the gel comprising a plurality of charged molecules of the biological sample, and the gel, the platform, the positive electrode and the negative electrode being immersed in the electrophoresis liquid;
a lid covering the electrophoresis tank and comprising a filter disposed above the gel and at least one luminous element disposed on at least one side of the filter to irradiate the gel so that the biological sample in the gel is excited to fluoresce; and
a power supply unit electrically connected to the positive electrode, the negative electrode and the luminous element so that an electric field is built across the positive electrode and the negative electrode to drive the charged molecules to move in the gel and provide the luminous element with electricity to luminesce.

2. The real-time fluorescent electrophoresis apparatus according to claim 1, wherein the lid is disposed surrounding the electrophoresis tank or is fixedly constructed on the electrophoresis tank.

3. The real-time fluorescent electrophoresis apparatus according to claim 1, wherein the lid comprises at least one anti-fog element, the anti-fog is electrically connected to the power supply unit and disposed on one surface of the filter of the lid to prevent vapor from being generated on the surface of the filter.

4. The real-time fluorescent electrophoresis apparatus according to claim 3, wherein the anti-fog element comprises at least one thermal wire to generate thermal energy on the filter.

5. The real-time fluorescent electrophoresis apparatus according to claim 3, wherein the power supply unit comprises a first power supply element and a second power supply element, the first power supply element provides the positive electrode and the negative electrode with electricity and the second power supply element provides the luminous element and the anti-fog element with electricity.

6. A real-time fluorescent electrophoresis apparatus, comprising:
an electrophoresis tank comprising a platform, an electrophoresis liquid, a positive electrode and a negative electrode, the platform being transparent and carrying a gel with a biological sample, the gel comprising a plurality of charged molecules of the biological sample, the platform comprising at least one luminous element therein to irradiate the gel on the platform so that the biological sample in the gel is excited to fluoresce, and the gel, the platform, the positive electrode and the negative electrode being immersed in the electrophoresis liquid;
a lid covering the electrophoresis tank and comprising a filter disposed above the gel; and
a power supply unit electrically connected to the positive electrode, the negative electrode and the luminous element so that an electric field is built across the positive electrode and the negative electrode to drive the charged molecules to move in the gel and provide the luminous element with electricity to luminesce.

7. The real-time fluorescent electrophoresis apparatus according to claim 6, wherein the lid is disposed surrounding the electrophoresis tank or is fixedly constructed on the electrophoresis tank.

8. The real-time fluorescent electrophoresis apparatus according to claim 6, wherein the lid comprises at least one anti-fog element, the anti-fog is electrically connected to the power supply unit and disposed on one surface or at least one side of the filter of the lid to prevent vapor from being generated on the surface of the filter.

9. The real-time fluorescent electrophoresis apparatus according to claim 8, wherein the anti-fog element comprises at least one thermal wire disposed on one surface of the filter to generate thermal energy on the filter.

10. The real-time fluorescent electrophoresis apparatus according to claim 8, wherein the anti-fog element comprises an outlet fan disposed on one side of the filter to deflate the electrophoresis tank during electrophoresis.

11. The real-time fluorescent electrophoresis apparatus according to claim 10, wherein the anti-fog element further comprises an inlet fan disposed on the other side of the filter to inflate the real-time fluorescent electrophoresis apparatus.

12. A real-time fluorescent electrophoresis apparatus, comprising:
an electrophoresis tank comprising a platform, an electrophoresis liquid, a positive electrode and a negative electrode, the platform being transparent and carrying a gel with a biological sample, the gel comprising a plurality of charged molecules of the biological sample, the platform comprising at least one luminous element therein to irradiate the gel on the platform so that the biological sample in the gel is excited to fluoresce, and the gel, the platform, the positive electrode and the negative electrode being immersed in the electrophoresis liquid;
a base comprising a bottom portion and a vertical portion, the electrophoresis tank disposed on the bottom portion, the bottom portion comprising an inlet fan with a air inlet and the vertical portion comprising an aperture to define a air flow path between the air inlet and the aperture so that a air flow is driven by the inlet fan into the air inlet to pass the air flow path and is discharged from the aperture;
a filter disposed above the gel and fixedly on the vertical portion of the base so that a gap is defined between the filter and the electrophoresis tank;
a air outlet disposed opposite to the gap so that the air flow discharged from the aperture passes through the gap to carry away the vapor on the filter out of the air outlet; and
a power supply unit electrically connected to the positive electrode, the negative electrode, the luminous element and the inlet fan so as to build up an electric field across the positive electrode and the negative electrode to move the charged molecules in the gel and provide the luminous element and the inlet fan with electricity.

13. The real-time fluorescent electrophoresis apparatus according to claim 12, wherein the air inlet is disposed on a bottom surface of the bottom portion and the bottom surface is provided with a plurality of pillars.

14. The real-time fluorescent electrophoresis apparatus according to claim 12, wherein the air inlet is disposed on one lateral side of the bottom portion.

15. The real-time fluorescent electrophoresis apparatus according to claim 12, wherein the filter is fixedly disposed on the vertical portion of the base by contacting of a connecting portion.

16. The real-time fluorescent electrophoresis apparatus according to claim 12, wherein the filter is disposed on a side frame that is fixedly disposed on the vertical portion of the base.

17. The real-time fluorescent electrophoresis apparatus according to claim 12, further comprising a pair of side plates disposed on both sides of the base.
